(19) United States
(12) Patent Application Publication
(10) Pub. No.: US 2004/0125125 A1
(43) Pub. Date: Jul. 1, 2004

(54) Embedded data windows in audio sequences and video frames

(76) Inventor: Kenneth L. Levy, Stevenson, WA (US)

Correspondence Address: DIGIMARC CORPORATION, 19801 SW 72ND AVENUE, SUITE 250, TUALATIN, OR, 97062, US

(21) Appl. No.: 10/602,549

(22) Filed: Jun. 23, 2003

Related U.S. Application Data
(60) Provisional application No. 60/392,384, filed on Jun. 29, 2002.

(51) Int. Cl. G09G 5/00

(52) U.S. Cl. 345/716

(57) ABSTRACT

The present invention provides steganographic data hiding systems and methods in which identification data is embedded in video so as to be below human perception. The identification data is embedded to be visually perceptible when the video is examined on a frame-by-frame basis. The identification data is steganographically hidden since the identification data is embedded in selected frames over time at a low repetition rate—causing the identification data to be imperceptible during real-time viewing of the video. Related systems and methods are provided for audio.

### RELATED APPLICATION DATA

The present application claims the benefit of U.S. Provisional Patent Application No. 60/392,384, filed Jun. 29, 2002, which is herein incorporated by reference.

### FIELD OF THE INVENTION

The present invention generally relates to identifying media content and steganographically hiding data. More particularly, the present invention relates to identifying and hiding data within audio and video media content.

### BACKGROUND AND SUMMARY OF THE INVENTION

We have all seen the street vender with a table of videos strategically positioned at the subway entrance or city sidewalk. Amazingly, a video costs a mere $4.00 on such a table—much cheaper than the price of a movie admission, not to mention cheaper than the cost of a video at the store. More amazingly, the movie has not yet been released on VHS or DVD. The realization settles in that the video is a bootlegged or misappropriated copy. The video is illegal—a form of modem-day piracy.

These modem-day pirates sneak into theaters armed with video recorders or digital camcorders. They sell their bootlegged copies for pennies on the dollar—robbing artists and the entertainment industry of billions. The rational that the entertainment industry still makes a bundle of money seems a hollow justification for allowing these thieves to operate unabated.

Sometimes the piracy is less obvious. Copies of yet to be released films are frequently stolen—or illegally leaked—from a movie studio, only to be later posted on the internet.

Video content can be marked to help identify the video—and perhaps the expected distribution channel in which the video is to travel. There are advantages to marking video, such as conveying copyright information, providing copy protection, identifying adult content, forensic identification, etc.

One form of marking is achieved through so-called digital watermarking. Digital watermarking technology, a form of steganography, encompasses a great variety of techniques by which plural bits of digital data are hidden in media content, preferably without leaving human-apparent evidence of alteration.

Digital watermarking may be used to modify media content to embed a machine-readable code into the media content. The media may be modified such that the embedded code is imperceptible or nearly imperceptible to a viewer, yet may be detected through an automated detection process. Digital watermarking systems typically have two primary components: an embedding component that embeds the watermark in the media content, and a reading component that detects and reads the embedded watermark. The embedding component embeds a watermark by altering data samples of the media content. The reading component analyzes content to detect whether a digital watermark is present. In applications where the watermark encodes information, the reading component extracts this information from the detected watermark. Assignee's U.S. patent application Ser. No. 09/503,881, filed Feb. 14, 2000, discloses various encoding and decoding techniques. U.S. Pat. Nos. 5,862,260 and 6,122,403 disclose still others. Each of these patent documents is herein incorporated by reference.

Digital cinema provides a venue to showcase digital watermarking's many advantages. See, e.g., assignee's U.S. patent application Ser. No. 10/028,751, filed Dec. 21, 2001 (published as US 2003/0012548 A1), for a further discussion of digital cinema and digital watermarking. These patent documents are herein incorporated by reference. Among other abilities, watermarking can provide:

1. Content Identification;

2. Copy protection;

3. Distribution identification; and

4. Exhibition identification.

These watermarks are applicable to movies, whether played at a traditional theatre or on a home TV or PC. I use the terms “video,” “motion picture” and “movie” interchangeably in this document. Of course, video is defined as including a sequence of image frames.

Some exemplary requirements for a video digital watermarking system include:

Robust to camcorder recording

Robust to digital compression, such as conversion to MPEG-4

Imperceptibility (completely or nearly imperceptible)

For audio, it is also advantageous to identify the content and recipient of streamed audio in music services such as PressPlay and MusicNet. Objectives for such a an audio system may include:

1. Content identification

2. Recipient account identification

Similar objectives are desirable for downloaded digital audio, and CDs pre-released to music critics. Digital watermarking can be employed to achieve these objectives. Preferably, such an audio digital watermarking scheme provides a watermark that is:

Robust to digital compression, such as conversion to MP3

Robust to analog conversion

Inaudible (completely or nearly inaudible)

According to a first aspect of the present invention, I provide steganographic hiding systems and methods in which identification data is embedded in video—preferably below human perception. By using the term “perception,” I am not necessarily implying that the watermark data is embedded to be visually imperceptible when the video is examined on a frame-by-frame basis. Indeed, I anticipate that many of my implementations will embed identification data that is visually perceptible if a particular embedded frame is visually inspected. (In fact, this is an advantage of some embodiments; specifically, a human can visually read the identification data from a frame without requiring a computerized detector.). Rather, the “below perception” aspect of the invention results from placing identification data in frames that are selectively staggered throughout the video. For example, identification data is placed in 1 out of every 15 (or 30 or so) frames. A data detector can find the embedded identification data and directly interpret the embedded data. The identifying data is steganographically hidden since the identification data is embedded in select frames over time at a low repetition rate—causing the identification data to be imperceptible during real-time viewing of the video.

In some implementations a detector uses the repetition rate to average the windows to increase the signal to noise ratio for the embedded data.

According to another aspect of the present invention, identification data is placed in an audio signal at a low sound level, possibly band pass filtered, and/or in short segmented low-level sounds, and either method is repeated across time in the audio signal at a low repetition rate.

Our inventive steganographic data hiding techniques are minimally visually perceptible and provide robustness to analog conversion, such as camcorder recording, and digital compression.

Further features and advantages of the present invention will become even more apparent with reference to the following detailed description and accompanying drawings.

### BRIEF DESCRIPTION OF DRAWINGS

FIG. 1 shows a video frame including identification data embedded therein.

FIG. 2 is a diagram showing a video sequence including two embedded frames.

FIGS. 3a and 3b are diagrams showing various video sequences including embedded frames.

FIG. 4 shows an audio signal including message windows or segments embedded therein.

### DETAILED DESCRIPTION

Introduction

By way of introduction, I present a brief overview of some techniques—dare I say subliminal techniques—which provides information with audio and video.

U.S. Pat. No. 4,717,343, issued on Jan. 5, 1988, and herein incorporated by reference, deals with a method of changing a person's behavior. The method conditions a person's unconscious mind as a person is treated to a program of video-pictures appearing on a screen. The program as viewed by the “unconscious” mind acts to condition the person's thought patterns to alter that person's behavior. The program sequence includes a combination of different images, strategically arranged in a sequence to influence a person's thought pattern.

U.S. Pat. No. 3,278,676, issued on Oct. 11, 1966, and herein incorporated by reference, discloses an apparatus for producing visual and auditory stimulation for television signals. Visual stimulation is carried out by flashing subliminal subject matter within the vision of the individual involved, but at such temporal duration, repetition rate, and/or light intensity as to make the subject matter imperceptible to the conscious level of awareness of the individual.

U.S. Pat. No. 4,395,600, issued on Jul. 26, 1983, and herein incorporated by reference, deals with an auditory subliminal message system and method. A control circuit adjusts the amplitude of an auditory subliminal anti-shoplifting massage to increase with increasing amplitudes of ambient audio signals and decrease with decreasing amplitudes of ambient audio signals. The amplitude controlled subliminal message may be mixed with background music and transmitted to a shopping area.

Let me be clear that I am not trying to change people's behavior with my inventive techniques. Instead, the majority of my inventive techniques place identifying data in audio and video at a repetition rate that is preferably not even subconsciously detectable by a human viewer of the video. In some implementations, where the identifying data is subconsciously detectable (but not consciously detectable), the detectable data is benign, such as a binary, Hex or decimal number, identifying text, etc.

Video Frame Embedding

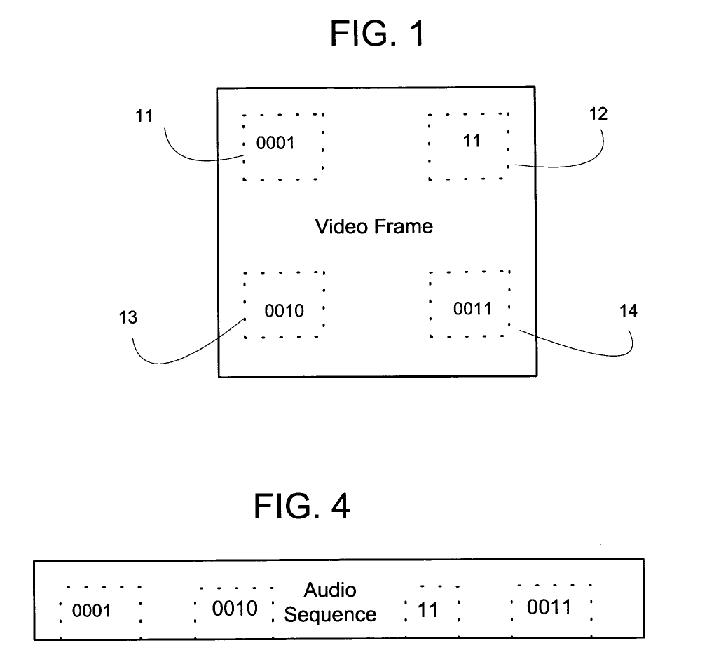

FIG. 1 illustrates a video frame 10 including a plurality of location windows 11, 12, 13 and 14. The location windows respectively identify or define areas in which data is placed to identify or mark the video. In one implementation, information within the window areas is visually perceptible when viewing an individual frame. (As discussed below, the information becomes imperceptible when a plurality of frames are rendered or played.). The identifying data can identify a range of information associated with the video. A few examples are:

1. Content Identification;

2. Copy control information;

3. Distribution identification; and

4. Exhibition identification.

The content identification (e.g., window 11) uniquely identifies the content. The identification may include a serial number, such as a binary, hexadecimal or decimal number, etc. Or the identification may include an alphanumeric identifier such as a text title or alphanumeric code. In some implementations, the content identification identifies content that is specific to a certain database or storage scheme. The database or scheme can be identified through, e.g., the distribution identification (discussed below). In other implementations, the content identification identifies an owner of the content (e.g., a movie studio, production company, artist, etc.). Hexadecimal, or similar numbering systems, can be optimal in some implementations since they pact the most information (i.e. numbering space) in a smaller spatial window (i.e. physical space).

The copy control information (e.g., window 12) provides an indication of permissible use of the video. The copy control information may announce that the video should never be copied, or should be copied only under certain circumstances. In some implementations, the copy control information is machine-readable. A detector automatically detects the machine-readable code. The detected code is analyzed to determine whether the video can be permissibly copied. (Consider a camcorder that while it is recording looks for copy control information. If found the camcorder can disable recording, or can alter the record data, e.g., by recording at a lower fidelity or lower image resolution.) The copy control information can alternatively identify copyright information.

The distributor identification (window 13) preferably identifies the distributor or expected distribution channel in which the video will travel. As with the content identification, this identification need not be a numeric identifier. Indeed, the identification can be provides as text as well.

The Exhibition identification (window 14) preferably identifies the target location (or entity) where the video will be shown. For example, this identification may indicate a theater name or location, viewing screen, early releases, rough cuts, etc. The identification can include numeric or text information. It can also include date and time of release. The time can be used to determine if the video is a legitimate showing, or special showing for a private group or individual.

An embedder embeds or otherwise places the location windows (or more accurately, the identification data within a window location) in a video frame using, e.g., conventional digital editing software, such as Adobe Premier™. The embedded (or placed) identification data will preferably be visible. That is to say that a visual inspection of an embedded, individual frame should reveal the identification data. The window location within a frame is not critical to the invention. A window location can be near a frame edge to minimize its intrusion in the video. Note, however, that a window location near a frame edge renders the window susceptible to cropping, so a centralized location in a video frame provides a more robust identification scheme.

In one implementation, an image is inserted over or pasted in a designated location window area. The image includes the identification data. The background of the image can be color, transparent, or blended with characteristics of neighboring or replaced video frame content. In another implementation, pixels or images within a window location are modified to accommodate or create the identification data. The video content within the window location can be screened, darkened, or brightened by a percentage, or a more complex process such as soft light at 30% (as provided by Adobe Photoshop™) can be employed achieve or create the information data. Video content in a widow location can alternatively be modified, e.g., through luminance changes or by changing one or more color (R, G, or B) channels, to accommodate the identification data. Indeed, a variety of techniques can be used to place identification data within a window location in a video frame.

If the identification data includes text, the text can even be in outline or shadow form.

In some implementations, the perceptual Weber fraction, ΔI/I, is followed for my embedding, where “I” is intensity and “ΔI” is a change in intensity for content in a video frame. Specifically, the embedded window changes the intensity I of a frame area by less than or near ΔI that is visible. (We can also view the intensity and intensity change in terms of the existing intensity at the window location relative to the identification data.). In fact, multiplying the luminance by a percentage of the video frame for each number or outline of each number, as described above, follows the Weber law.

Alternative Embedding Techniques

In an alternative embedding implementation, identification data can include a pseudo-random (PN) sequence, of ones (1) and zeros (0). (I anticipate that a “1” and “0” can either be represented in numeric form or through an image binary representation effectuated, e.g., by pixel or luminance tweaks). The PN sequence would be harder to detect—and thus remove—while the PN sequence remains visible in an embedded frame. The PN sequence could be additive where ones brighten and zeros darken, or could be multiplicative so the PN sequence appears more like random noise. A tradeoff with this implementation is that while embedded data is harder to remove in a frame, it is less visible for detection and thus less robust to compression and camcorder recording and subsequent compression for re-distribution. (In a related but alternative implementation, the spatial location of a window is slightly changed, such that sequential embedded frames have different, but still overlapping windows. This technique will even further reduce the perceptibility of the identification data when video is rendered or played in real time. Averaging the windows over a series of embedded frames provides a detectable data field.).

In a related implementation, the embedded data window, viewed as a bitmap where 1 is black and 0 is transparent, is doubled in size in each direction (quadrupled in total). Each embedded data value 1 is turned into two patterns, A and B, of 1's and 0's. Thus, 1's are turned into four 1's, where two 1's go to pattern A, and the other two 1's go to pattern B. And 0's are turned into randomly (or pseudo-randomly) selected 1's and 0's for both patterns A and B. The pattern A is embedded in the frame at the window location. The pattern B is saved for verification and detection. More specifically, the window pattern A can only be read by placing the private pattern B over the embedded pattern, where 1 is dark and 0 is transparent. This process causes a text-based image to visually appear as black with a gray background, e.g., when viewed by a person. The gray background is due to half of the 0's turning to 1's and the black image is due to all of the 1's remaining 1's, when the two images are overlapped. Thus, the private pattern is required to read the data, and private embedded data is allowed. This is different than just multiplying the image by a PN sequence, since this multiplication uses the same key for embedding and detection, whereas the above process has a private detection key B. However, with respect to pseudorandom (PN) sequences, this technique can be augmented to use a private key for detecting. More specifically, the overlay of the private key and embedded data is used to capture a full PN sequence to detect a more traditional digital watermark.

In still another alternative implementation, identification data is conveyed in the form of a conventional digital watermark, such as those based upon, e.g., adding or subtracting pseudo-random sequences to carry data. For example, watermark data can be spread over a window area. Or information can be conveyed through tweaks in color levels, luminance or intensity. This conventional watermark can be added very strongly to each frame, or data windows for each frame, but remains imperceptible in a real-time rendering of the video sequence. The embedding strength allows for easier detection as a detector looks at a watermarked frame or average of frames. These watermarks are preferably robust to compression due to high intensity (or signal strength) embedding levels, and although potentially visible on a per frame basis, the watermarks are imperceptible with real-time rendering of the video sequence. In a related implementation, we use a private key for as an embedding key (or PN sequence) to provide private data.

Placement of an Embedded Frame within a Video Sequence

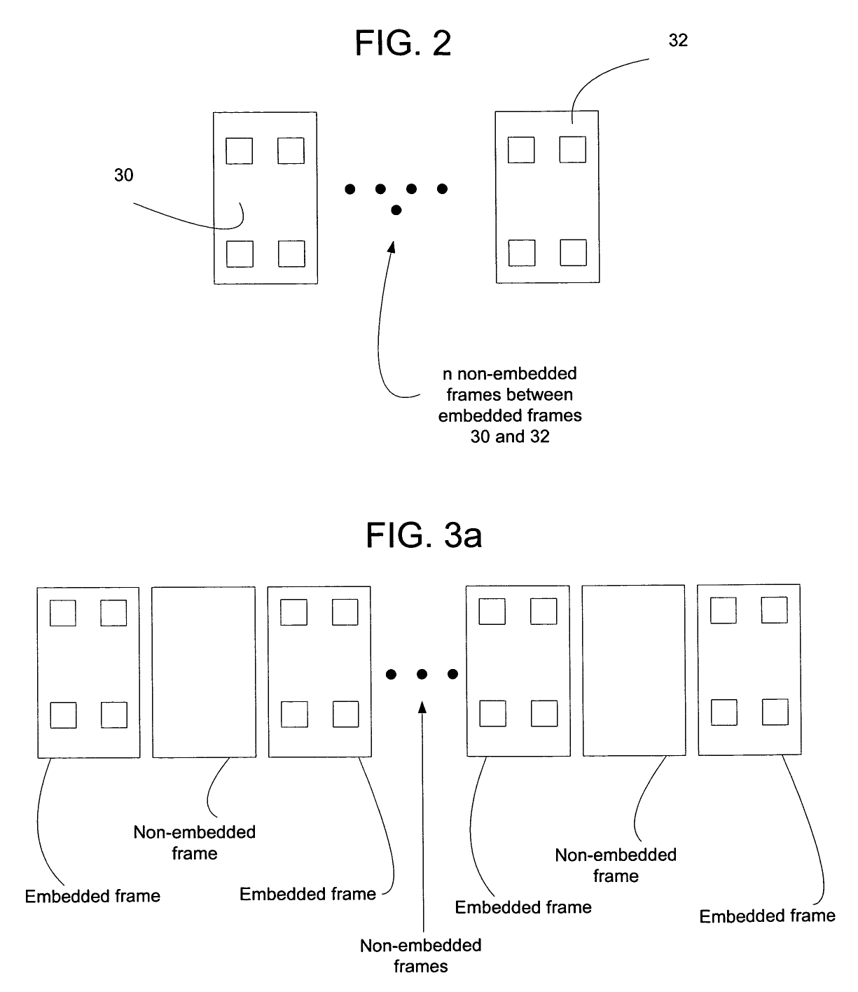

Up to this point in the disclosure, the focus has been on embedding a single frame with identification data. While I use the term “embedding,” the identification information does not have to be “hidden” from view in a given a frame. Yet my goal is to provide steganographic identification of a video sequence. So, of course, not every video frame of a video sequence is so embedded, so that when rendering the video sequence, the embedded identification data becomes imperceptible. I space out the embedding of frames in a video sequence so that the presentation of identification data is imperceptible since it is flashed (or rendered) at a rate that is below human consciousness or recognition. The conscious human mind will not perceive the embedded identification data if it is sufficiently spaced in a video sequence. With reference to FIG. 2, embedded video frames 30 and 32 are separated in a video sequence by n frames, where n is an integer selected to ensure that the information data, while visible in each of frames 30 and 32, is not perceived when the video sequence is played. (Note that the frames 30 and 32 are not removed from their natural frame sequence in a video sequence.)

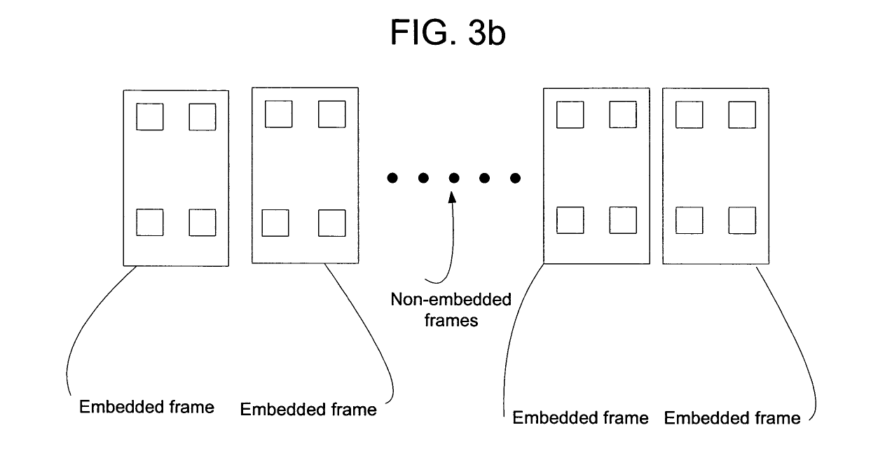

Location windows can be embedded at various intervals and sequence patterns to help thwart piracy. For example, as shown in FIG. 3a, we can embed a frame, then skip a frame, and then embed the next frame. Or we can embed consecutive frames as shown in FIG. 3b. The embed-skip-embed example can have effects on video sequence recorded by video cameras such that the identification data becomes visible and lowers the value of the recorded video. The visibility results from the fact that most consumer video cameras record at around 30 frames-per-second (fps) while theater video is rendered at about 24 fps. As such, the video camera is recording more than one frame for each displayed frame, and the embedded data window may be duplicated and become visible. The closer the embedded data window is to visibility in the video and more times, especially in close proximity, that the embedded data windows are shown, the more likely it will become visible in the camcorder recording. (Experiments where embedded video has been converted from 24 fps to 30 fps on a PC and viewed by the inventor have shown that data embedded in one frame may be nearly imperceptible, but when repeated as in FIGS. 3a or 3b, it becomes more perceptible.).

Indeed, to thwart bootleggers, location windows can be embedded in frames at a rate of about one for every second of video, e.g., embed one out of every 24 frames for video to be broadcast in theaters or one out of 30 frames for NTSC (i.e. US) TV. In a related implementation, the embedded data does not carry identification data. Rather, the embedded data comprises an image or text message that is obtrusive as it is perceptually captured by a camcorder. The obtrusive image as it becomes visible due to the higher camcorder-recording rate spoils a camcorder-recorded image.

While it is helpful (from a detection perspective) to have embedded frames placed at constant intervals through a video sequence, the present invention is not so limited. Indeed, the repetition rate can be varied. The averaging techniques discussed below can be used to better detect the embedded information data. The averaging detection technique works better if the variation is a known pseudorandom sequence (i.e. key), but can work for unknown random sequences as well.

Referring back to FIG. 1, not all four location windows are needed in every application. In fact, there are many cases where only one window, e.g., the content identification is needed. Note that it is helpful to have the location window be consistently located throughout a video sequence for ease of detection.

In a video sequence including embedded frames, not all of the four location windows—even if all are used—need to be shown or included in each embedded frame. One location window may be used per embedded frame, and every x frames, where x is usually greater than 10, another window is used to carry the other identification data. After information is presented for each of the different windows, the windows can be repeated. Optimally the windows for the different identifiers are not located in the same frame location.

To even further obscure the information data from human perception—perhaps even below subconscious detection—embedded windows are repeated in a video sequence a-periodically with respect to human alpha brain waves. (Alpha waves represent non-arousal activity. Alpha brainwaves are slower, and higher in amplitude when compared to other brain waves. Their frequency ranges from about 9 to 14 cycles per second. A person in a relaxed or meditative state will often exhibit alpha waves.). Accordingly, we can limit the placement of embedded frames to about 3 embedded frames per second, or even 1 embedded frame per second and a half. The identification data will be less likely to be detected by the sub-conscious mind since the embedded data window rate is different than the alpha waves (based upon the assumption that humans are most likely to consciously or sub-consciously perceive objects presented during the peak or at the periodic rate of the alpha wave). In other words, the identification data is ideally neither consciously nor sub-consciously perceptible. However, it is acceptable for the identification data to be sub-consciously perceptible so long as perception does not detract from a viewer's viewing experience.

Detection

My inventive embedding techniques lend themselves to both manual and automated detection. Manual detection can involve a person looking at an embedded frame and reading the data. Automated detection can involve use automatic optical character (or number) recognition (OCR). Or if the identification data is embedded in the form of a digital watermark (e.g. a PN sequence), a digital watermark decoder can be used. Still further, if the identification data is in the form of other machine-readable data (e.g., a 2-D barcode), a corresponding detector can be used.

To improve detection (e.g., SNR), a detector can average many frames in a video sequence, and the embedded identification data will cumulate, as long as the identification data and spatial window location does not change for each location window, while other video frame content will cancel out over a long period of time since it is essentially random in such averaging.

If the embedded identification data is repetitiously added based, e.g., upon linear equations, then a detector (or video rendering device) can remove the identifying data in a video sequence to recover the original video by using the inverse process of embedding (assuming digital quantization does not cause any harmful effects). If a private pattern is used to embed the data (or to vary the sequencing of embedded frames), a key or other sequence indicator can be used to help remove or detect the identification data.

For detectors based upon averaging multiple frames to find the embedded data, it's always optimal to only average the frames with the embedded data window, but the system can work when all frames are averages as well. As such, the embedded frames do not need to be known by the detector.

If embedded data window locations are varied, then an averaging detector should re-orient each frame so at least one embedded data window overlaps for average based detection.

Embedding Audio

My inventive techniques can be applied to audio with a few apparent modifications. First, while my video techniques typically embed visible data, an audio segment is embedded with audible identification data (e.g., audible words, sounds, frequency fluctuations, etc.). Second, audio windows are embedded in an audio segment sequentially over time (rather than spatially in a frame as in my video embodiments). However, the audio bits can be separated to reduce the chance of audibility.

With reference to FIG. 4, audio windows may include:

1. Content identification (41) in, e.g., the first minute of audio;

2. Copy control information (42) in, e.g., the second minute of audio;

3. Distribution identification (43) in, e.g., the third minute of audio; and

4. Exhibition identification (44) in, e.g., the fourth minute of audio.

As with the video implementations above, not all four windows need to be implemented. One window may be enough for the whole audio segment, such as a content identification.

The identification can be a unique number, as shown in FIG. 4, or text. For example, the content identification could be the audible name of the song.

An audio embedder embeds the audio window in the audio sequence using conventional digital editing software, such as Sonic Foundry's SoundForge™. The embedded audio window can be reduced in amplitude in the audio so it is not consciously perceived. In one implementation, an audio window (e.g., identification data) can be embedded in every minute of audio. Thus, four audio windows will take about 4 minutes of audio segment. In some cases the identification data includes audible messages such as “ONE,” “ZERO,” “ADE501.” Take for example, an identification code of 0101. The actual audible words “ZERO,” “ONE,” “ZERO,” “ONE” can be read aloud (or audibly pronounced) at a rate of about a half second per individual word. (In one experiment I determined that I could read aloud at a rate of about 32 words in 15 seconds.).

In a first implementation, each bit (e.g., in the case of a binary system, the audible words “ONE” and “ZERO”) or digit (e.g., in a decimal system, the audible pronunciation of numbers “1”, “2”, etc., or hexadecimal, which has optimal information per hexadecimal character) of the identification data is embedded (or inserted) according to a predetermined pause of, e.g., every 100 milliseconds, such that the identification data is more transient and less likely to be audibly perceived.

There are many other audio embedding techniques, besides inserting audible words into an audio segment that can be used to embed identification data in an audio segment. The identification data can be used to modify an audio segment via multiplication (while still obeying the perceptual Weber fraction, ΔI/I) or convolution, or by changing a frequency to a less perceptible frequency, or changing it a higher or lower frequency, etc. (Note that a frequency change should not be too large so as to make it easy to filter the audio and remove the embedded identification data.). Regardless of the audio embedding technique used, the audible identification data is preferably below the conscious perceptual threshold of a listener.

To this end, an embedding signal level can be such that the average level of the embedded identification data is below the average level of the audio (e.g., 20 dB below the average level). Alternatively, the audio could be broken into spectral critical bands, and each band of embedded identification data is kept at, e.g., 20 dB or greater below, the average level of the audio in that critical band. As such, the spectral portions of the audio will be perceptual. If more frequency components are used the audio window is less likely to be perceived, but at a cost of complexity in the embedding process.

In addition, the audible sequence of the embedded identification data may be scrambled by multiplying by a PN sequence key—or embedded as bits in that PN key. Alternatively, the audio windows can be modified by pseudo-random (PN) sequence, of around equal numbers 1's and 0's, so the identification data is harder to remove but is still audible. The PN sequence is preferably multiplicative, so as to sound more like noise.

Audio Detection

A detector of imperceptibly hidden, yet audible data, can be a person or a speech recognition engine (trained on numbers or text) listening to audio sequences. Audio segments are preferably averaged in our preferred audio detection technique. Proper averaging implies that audio segments are selected to match the length of the embedded audio window, such that the embedded audio windows align when the audio segments are overlapped and added. The averaging will cause the embedded audio windows to increase in level and the audio sequence to cancel out since it will be random over time, thus increasing the SNR.

Preferably, in a detection process, averaging several segments of audio will help detect the embedded identification data since the embedded audio data will add and the audio will average to noise. When the embedded audio data is changed in each critical band, they should average back close to flat, assuming the audio is flat over time, or, at a minimum, take on the average spectral shape of the audio. In either case, the embedded identification data will be audible for detection.

Conclusion

The foregoing are just exemplary implementations of the present invention. It will be recognized that there are a great number of variations on these basic themes. The foregoing illustrates but a few applications of the detailed technology. There are many others.

To provide a comprehensive disclosure without unduly lengthening this specification, applicant incorporates by reference, in their entireties, the disclosures of the above-cited patents and applications. The particular combinations of elements and features in the above-detailed embodiments are exemplary only; the interchanging and substitution of these teachings with other teachings in this application and the incorporated-by-reference patents/applications are expressly contemplated.

The various section headings in this application are provided for the reader's convenience and provide no substantive limitations. The features found in one section may be readily combined with those features in another section.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

I claim:

1. A method of embedding identification data in video, the video comprising a plurality of video frames, said method comprising the steps of:
embedding the identification data in a first video frame, the embedded identification data being visually perceptible upon examination of the first frame;
selecting a second video frame, wherein the first and second video frames are separate frames; and
embedding the identification data in the second video frame, the embedded identification data being visually perceptible upon examination of the second frame, wherein the identification data is generally imperceptible upon real-time rendering of the video.

2. The method of claim 1, wherein the selecting step comprising selecting the second frame so that the repetition of the embedded identification data is imperceptible to the human conscious mind when rendered.

3. The method of claim 1, wherein the identification data is embedded in the same frame location in each of the first and second frames.

4. A detection method for the video embedded according to claim 1, comprising the step of visually inspecting the first or second frames.

5. A detection method for the video embedded according to claim 1, comprising the steps of providing character recognition of the first or second frames to detect the identification data.

6. The method of claim 1 wherein the identification data is embedded in each of the first and second frames in the form of a digital watermark, yet the embedded digital watermarks remain visually perceptible upon examination of the first frame and second frame.

7. The method of claim 6, wherein the watermark visibility is due at least in part to watermark signal strength or intensity.

8. The method of claim 2, wherein the second frame is selected so that the repetition of the embedded identification data is imperceptible to the unconscious human mind.

9. The method of claim 1, wherein the identification data comprise at least one of text, numbers, codes, images and graphics.

10. The method of claim 3, wherein the same location comprises a window.

11. The method of claim 1, wherein the identification data comprise a plurality of identifiers.

12. The method of claim 11, wherein each of the plurality of identifiers is embedded to be spatially located in a separate frame location with respect to each other.

13. The method of claim 12, wherein the separate frame locations are the same for each of the first frame and second frames.

14. The method of claim 11, wherein the plurality of identifiers comprise a content identification, a distributor identification, copy restriction information, and an exhibition identification.

15. The method of claim 1, wherein the identification data comprises at least one of a content identification, a distributor identification, copy restriction information, and an exhibition identification.

16. A detection method for the video embedded according to claim 1, comprising the step of averaging a plurality of the video frames including the first and second frames, wherein the averaging improves the signal to noise ratio of the identification data to video content.

17. A method to deter unauthorized copying of video, the video to be projected onto or displayed on a viewing screen, the copying to be performed by a recording device, wherein the video comprises a sequence of video frames, said method comprising the steps of:
embedding identification data in a first video frame, the embedded identification data being visually perceptible upon examination of the first frame;
selecting a second video frame, wherein the first and second video frames are separate frames; and
embedding the identification data in the second video frame at generally the same frame location as in the first frame, the embedded identification data being visually perceptible upon examination of the second frame, wherein the identification data is generally imperceptible upon rendering of the video, but a video sequence separation distance between the first and second frames is selected such that the identification data becomes perceptible in a copy of the video captured with the recording device when rendered for viewing in real time, wherein the recording device includes a frame-capture rate that is higher than the projected or displayed frame rate for the video.

18. The method of claim 17, wherein the recording device comprises a handheld camcorder.

19. The method of claim 18, wherein the video comprises a movie and the rendering is at a theater.

20. The method of claim 17, wherein the identification data comprises an image.

21. The method of claim 17, wherein the separation distance comprises one video frame.

22. The method of claim 21 further comprising embedding the identification data in a third video frame at generally the same frame location as in the first and second frame, the embedded identification data being visually perceptible upon examination of the third frame, wherein the identification data is generally imperceptible upon rendering of the video, and wherein the second and third frames are separated by a distance sufficient to allow the embedded data to remain imperceptible upon rendering of the video, but further enforcing the perceptibility in the copy as captured by the recording device.

23. A method of marking content with auxiliary data, the method characterized in that the auxiliary data is embedded to be humanly perceptible if examined in a finite segment or frame of the content, but is embedded so as to be humanly imperceptible when examined as the content is rendered in real-time.

24. The method of claim 23, wherein the content comprises audio.

25. The method of claim 23, wherein the content comprises video.

26. A method of hiding identification data in an audio sequence, wherein the identification data comprises audible words or sounds, said method comprising the steps of:
providing the identification data for embedding; and
redundantly embedding the identification data throughout the audio sequence at a level below human audible perception,
wherein averaging segments of the audio sequence yields the identification data at a perceptible audible level.

27. A method of steganographically hiding data in media content, wherein the media content comprises a plurality of segments including masking content, said method being characterized in that at least two of the media segments are provided with the data, wherein the data comprises humanly perceptible data, and wherein the data remains perceptible upon individual examination of the at least two media segments but consciously imperceptible as the media content is rendered in real time since the data is below a perceptual threshold due to the masking content.

28. The method of claim 27 wherein the media content comprises video, the plurality of segments comprises video frames and the masking content comprises video frames without the data.

29. The method of claim 28, wherein the data comprises an image of at least one of a hexadecimal number, binary number and decimal number.

30. The method of claim 28, wherein the data comprises an image of text.

31. The method of claim 27, wherein the media content comprises audio and the plurality of segments comprise audio segments and the masking content comprises unembedded audio.

32. The method of claim 31, wherein the data comprises a voiced version or audible rendition of at least one of a hexadecimal number, binary number and decimal number.

33. A detector to detect the data provided according to claim 28, wherein the detector averages a plurality of the video frames so that the provided data becomes consciously perceptible.

34. A detector to detect the data provided according to claim 31, wherein the detector averages a plurality of the audio segments so that the data becomes consciously perceptible.
